(19) United States
(12) Patent Application Publication
(10) Pub. No.: US 2011/0268396 A1
(43) Pub. Date: Nov. 3, 2011

(54) ELECTRICAL CONNECTOR WITH OPTICAL MODULE

(75) Inventors: JIA-YONG HE, Kunshan (CN); QI-SHENG ZHENG, Kunshan (CN); ZHONG-HUA YAO, Kunshan (CN); YU-LONG MAO, Kunshan (CN)

(73) Assignee: HON HAI PRECISION INDUSTRY CO., LTD., New Taipei (TW)

(21) Appl. No.: 13/097,076

(22) Filed: Apr. 29, 2011

(30) Foreign Application Priority Data
Apr. 30, 2010 (CN) 201010161117.X

(51) Int. Cl. G02B 6/36

(52) U.S. Cl. 385/93; 385/92

(57) ABSTRACT

An electrical connector defines a receiving space for receiving a corresponding plug and comprises an insulative housing, a plurality of contacts disposed in the insulative housing, an optical module for engaging with an optical plug, and a shell covering the insulative housing to define the receiving space. The insulative housing has a body portion and a tongue extending forwardly from the body portion into the receiving space and a mounting slot behind to the receiving space. Each contact has a contact portion exposed in the tongue, and a tail portion extending beyond the insulative housing. The optical module is forwardly assembled into the mounting slot from a rear side of the insulative housing. The insulative housing provides a step portion protruding into a rear part of the receiving space to limit a movement of the optical plug inserted into the receiving space in a top-to-bottom direction.

### BACKGROUND OF THE INVENTION

1. Field of the Invention

The present invention relates to electrical connectors, more particularly to electrical connectors with optical module, which can transmit optical signals.

2. Description of Related Art

Personal computers (PC) are used in a variety of ways for providing input and output. Universal Serial Bus (USB) is a serial bus standard to the PC architecture with a focus on computer telephony interface, consumer and productivity applications. On 1994, Intel`Compaq`NEC`Digital`Northern`IBM`Microsoft cooperatively establish an industry standard body, USB Implementers Forum (USB-IF), which constitutes the original standard of USB, by now, USB-IF total release four specifications: 1.0 version, 1.1 version, 2.0 version and 3.0 version, and a transmitting rate of USB connector is obviously advanced.

A new type USB connector is adapted for transmitting optical signals to further improved the transmitting rate, such a USB connector usually includes an insulative housing, a plurality of contacts retained in the insulative housing, an optical modular and a shell surrounding the insulative housing. However, for miniaturization of mother board, single connector is hoped to be able to mate with more than one type mating plugs. However, it is know to all different mating plugs usually have different inserting depths and different heights, when this USB connector mates with an optical plug, a gap between the shell and the optical plug may cause a floating of the optical plug and influence a position precision between the optical modular and mating optical element, that will infect a normal work of the USB connector.

Hence, an improved electrical connector is desired to overcome the above problems.

### BRIEF SUMMARY OF THE INVENTION

According to one aspect of the present invention, an electrical connector defines a receiving space for receiving a corresponding plug, and comprises an insulative housing, a plurality of contacts disposed in the insulative housing, an optical module, a shell covering the insulative housing to define the receiving space, and a step portion. The insulative housing has a body portion and a tongue extending forwardly from the body portion into the receiving space and a mounting slot behind to the receiving space. Each contact has a contact portion exposed in the tongue, and a tail portion extending beyond the insulative housing. The optical module is forwardly assembled into the mounting slot from a rear side of the insulative housing and having at least one lens exposed to the receiving space forwardly. The step portion extends into the receiving space, the step portion is disposed at a rear part of the receiving space near the body portion and the lens of the optical module is located between the step portion and the tongue in a top-to-bottom direction, the step portion reduces a height of the rear part of the receiving space above/under the step portion.

According to another aspect of the present invention, an electrical connector defining a receiving space for receiving the plugs adapted for mating with USB plug and optical plug which has a smaller height respective to the USB plug, comprises an insulative housing, a plurality of contacts disposed in the insulative housing, an optical module assembled to the insulative housing and a shell covering the insulative housing. The insulative housing has a tongue extending forwardly into the receiving space; each contact has a contact portion exposed in the tongue and a tail portion extending beyond the insulative housing. One of the shell and the insulative housing provides a step portion protruding into a rear part of the receiving space to limit a movement of the optical plug inserted into the receiving space in a top-to-bottom direction.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an electrical connector according to the present invention;

FIG. 2 is a view similar to FIG. 1, while taken from a different aspect;

FIG. 3 is a partly exploded view of the electrical connector shown in FIG. 1;

FIG. 4 is a view similar to FIG. 3, while taken from a different aspect;

FIG. 5 is a view also similar to FIG. 3, while taken from another different aspect;

FIG. 6 is a perspective view of an insulative housing of the electrical connector;

FIG. 7 is a sectional view of the electrical connector, taken along line 7-7 the FIG. 1;

FIG. 8 is an exploded view of the electrical connector;

FIG. 9 is another exploded view of the electrical connector;

FIG. 10 is a part sectioned view of the electrical connector mating with an optical plug;

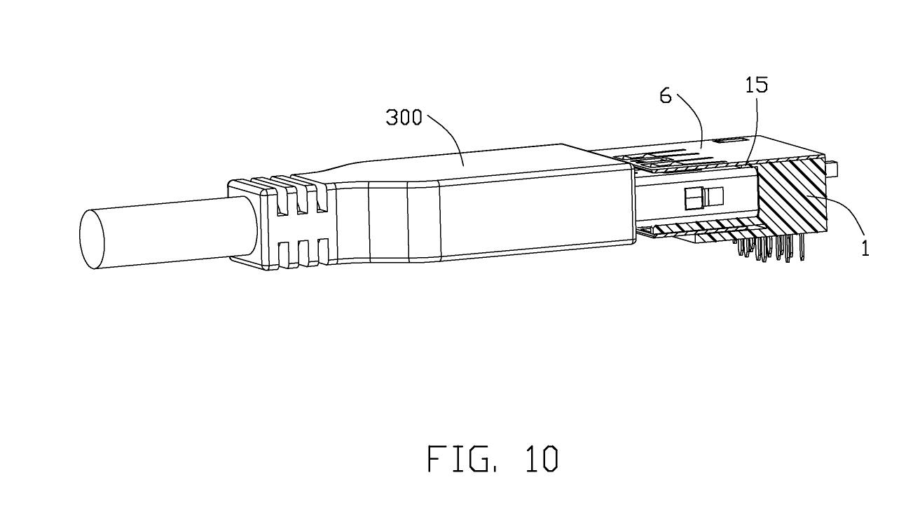

FIG. 11 is a part sectioned view of the electrical connector mating with a USB 3.0 plug; and

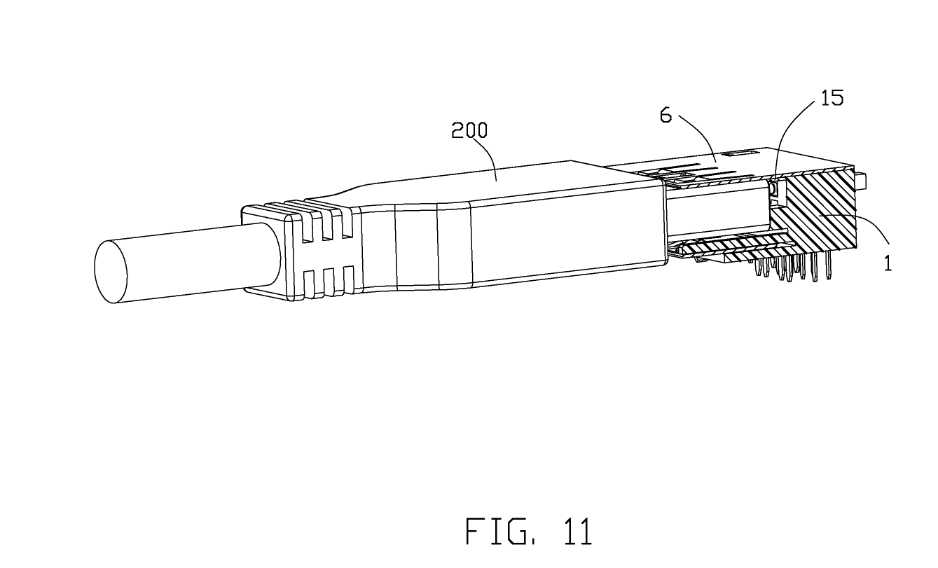

FIG. 12 is a perspective view of the electrical connector removed a shell thereof.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Reference will be made to the drawing figures to describe the present invention in detail, wherein depicted elements are not necessarily shown to scale and wherein like or similar elements are designated by same or similar reference numeral through the several views and same or similar terminology.

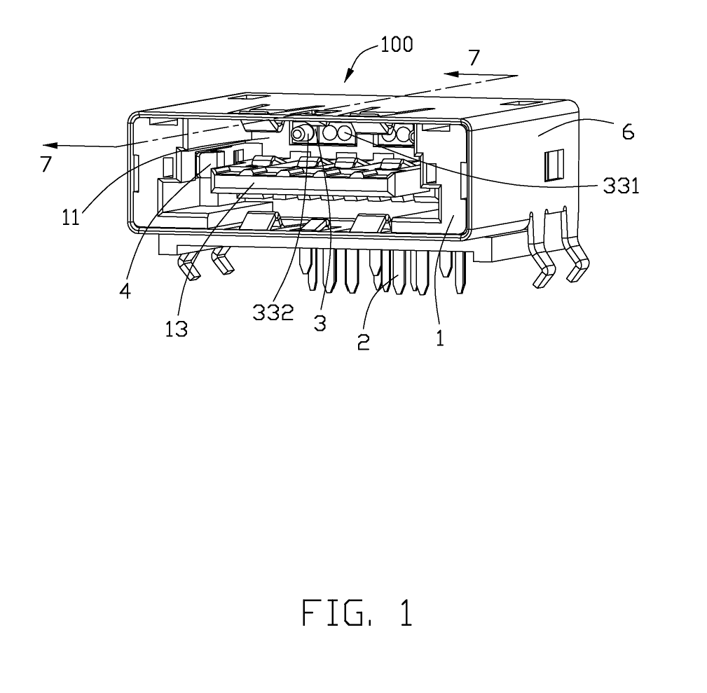

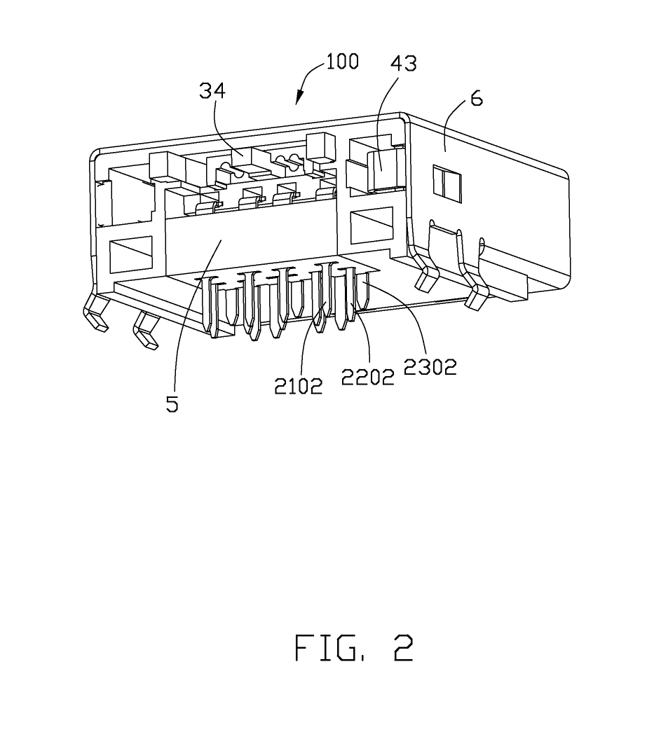

Referring to FIGS. 1-2, an electrical connector 100 according to present invention, is capable of engaging with various types of mating plugs, such as standard USB 2.0 plug (not shown), standard USB 3.0 plug 200, standard E-SATA plug (not shown), and optical plug 300 for transmitting optical signals. The electrical connector 100 comprises an insulative housing 1, a plurality of contacts 2, an optical module 3 and a pair of elastic pieces 4, a spacer 5 for positioning the contacts 2, and a metal shell 6 covering the insulative housing 1.

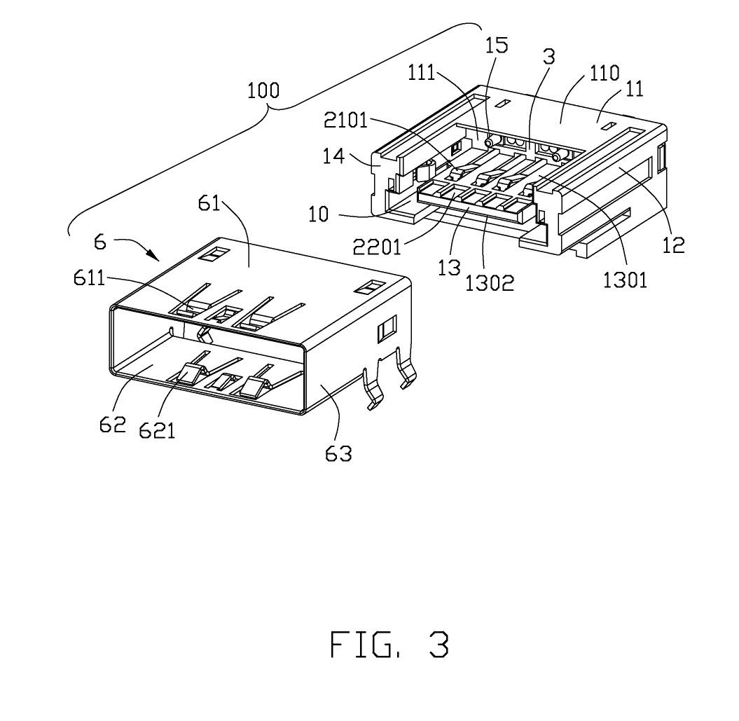

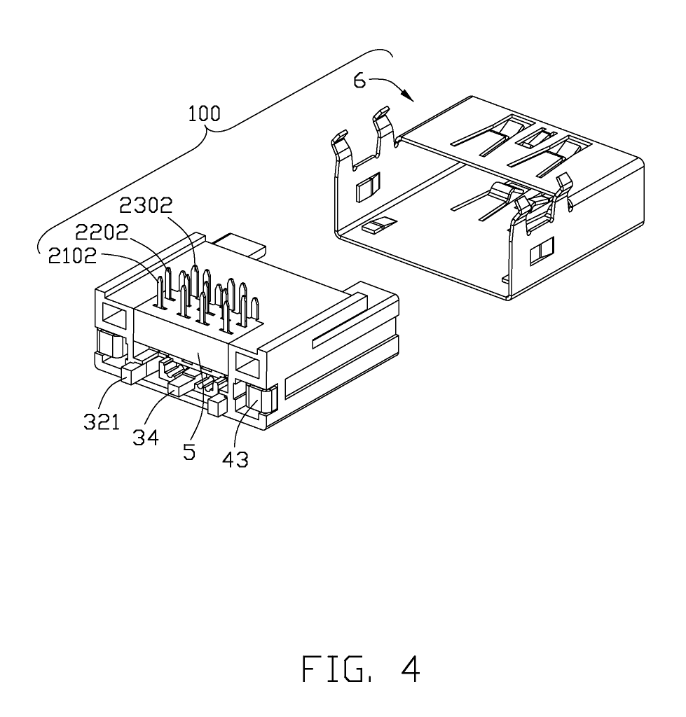

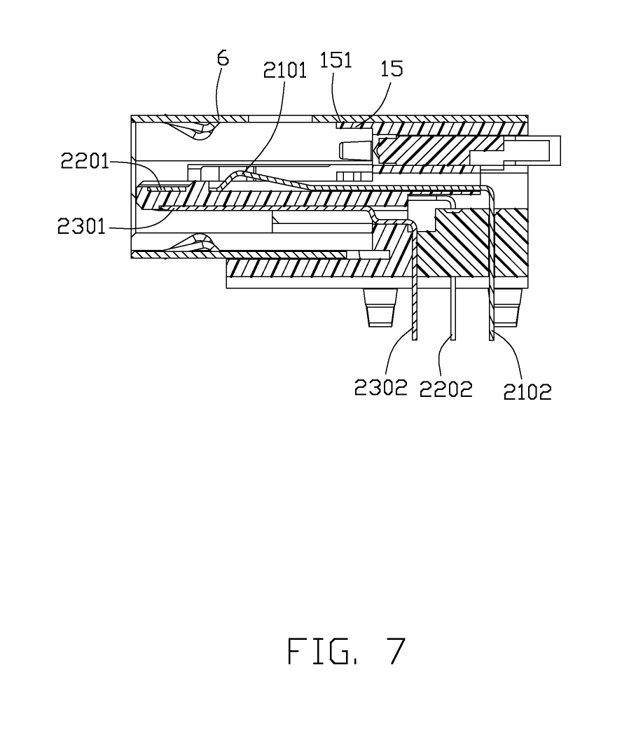

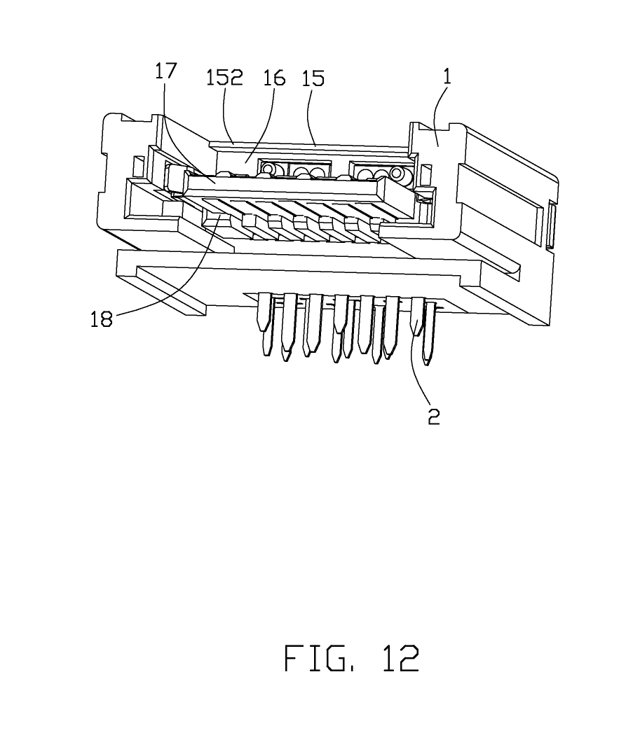

Referring to FIGS. 3-4 and 7-8, the insulative housing 1 has a body portion 11 at a rear portion thereof, a mating surface 14 at a front portion thereof and a receiving space 10 recessed from the mating surface 14 and located in front of the body portion 11. The body portion 11 is formed with a top surface 110, a front surface 111 and a rear surface 112. The insulative housing has a step portion 15 extending forwardly from the front surface 111 and located upon the receiving space 10 to limit an upward movement of the optical plug 300. The step portion 15 has a top surface 151 coplanar with the top surface 110 of the body portion 11 and a front surface 152. Since the optical plug 300 has a smaller height than that of the USB 2.0 plug or USB 3.0 plug, and a longer inserting depth than that of the USB 2.0 plug or USB 3.0 plug. Referring to FIG. 12, the body portion 11 has a limiting surface 16, which abuts against the optical plug 300 to make a front part of the optical plug 30 be located under the step portion 15, thus the optical plug 300 can not insert rearward further, so the limiting surface 16 to control an inserting position of the optical plug 300 and ensure a position precision of the optical plug 300. In present embodiment, a gap defined between an upper side of a front part of inserted the optical plug 300 and the step portion 15 is very narrow, and sometimes, such a gap is not existed, the upper side of a front part of inserted the optical plug 300 abut against the step portion 15, whatever, the optical plug 300 will not rock in a top-to-bottom direction, make sure the optical signals from the optical plug is in-line with the optical signals of the optical module 3 to prevent loss of optical signals.

In present embodiment, the shell 6 position both the USB 2.0 plug and USB 3.0 plug in the top-to-bottom direction to ensure a position precision of the USB 2.0 plug and USB 3.0 plug. Since the optical plug 300 has the smaller height than that of the USB 2.0 plug or USB 3.0 plug, a clearance between the optical plug 300 and the shell 6 may be little big, in present embodiment, the step portion 15 is used to fill the clearance to prevent the optical plug 300 from rocking in the top-to-bottom direction, then, the optical plug 300 can be well positioned. Furthermore, since only the optical plug 300 has the longer inserting depth than that of the USB 2.0 plug or USB 3.0 plug. In present embodiment, the step portion 15 is provided by the insulative housing 1, actually, the step portion 15 also can be formed from the shell or other means, the key is to fill the clearance between the optical plug 300 and the shell 6.

The insulative housing 1 has a tongue 13 horizontally extending from the front surface 111 of the body portion 11 into the receiving space 10 and be planar shape, and a pair of lateral portion 12 integrally extending from the body portion 11 and located on two sides of the body portion 11, a mounting slot 13 recessed forwardly from the rear surface 112, two mating holes 114 further recessed forwardly from the mounting slot 13 and communicating with the receiving space 10, a pair of latching recess 1130 recessed laterally from the mounting slot 113 and a cavity 115 under the mounting slot 113. The cavity 115 defines latching slot 1151 for positing the spacer 5 at a rear part thereof. The tongue 13 has a first side surface 1301 and a second side surface 1302 in an upper and a lower side, respectively. The first side surface 1301 defines four first grooves 1131 extending along a front-to-back direction and queued in a right-to-left direction and five rectangular second grooves 1132 in front of the first groove. The second side surface 1302 defines seven third grooves 1133 extending along a front-to-back direction and queued in a right-to-left direction and recessed upwardly.

The mating holes 114 have a rectangular shape and queued in the right-to-left direction, and located on an upper side of the first side surface 1301. Referring to FIG. 12, the tongue 13 is formed with a second limiting surface 17 and a third limiting surface 18, the second limiting surface 17 abuts against the USB 2.0 plug or USB 3.0 plug to prevent the USB 2.0/3.0 plug from further inserting which may touch the step portion 15, the third limiting surface 18 abuts against the E-SATA plug to prevent the E-SATA plug from further inserting, the second limiting surface 17 is located in a front of the first limiting surface 16, and the third limiting surface is located between the first limiting surface 16 and the third limiting surface 18. So that, the second limiting surface 17 and the third limiting surface 19 ensure an inserting positions of the USB 2.0/3.0 plug and the E-SATA plug, respectively. A extending dimension of the step portion 15 is decided by inserting positions of the USB 2.0/3.0 plug, the key problem is make sure that the step portion 15 will not influence the normal insertion of the USB 2.0 plug or the USB 3.0 plug, while the inserted E-SATA plug is located under the step portion 15, so will not be influenced by a length of the step portion 15,

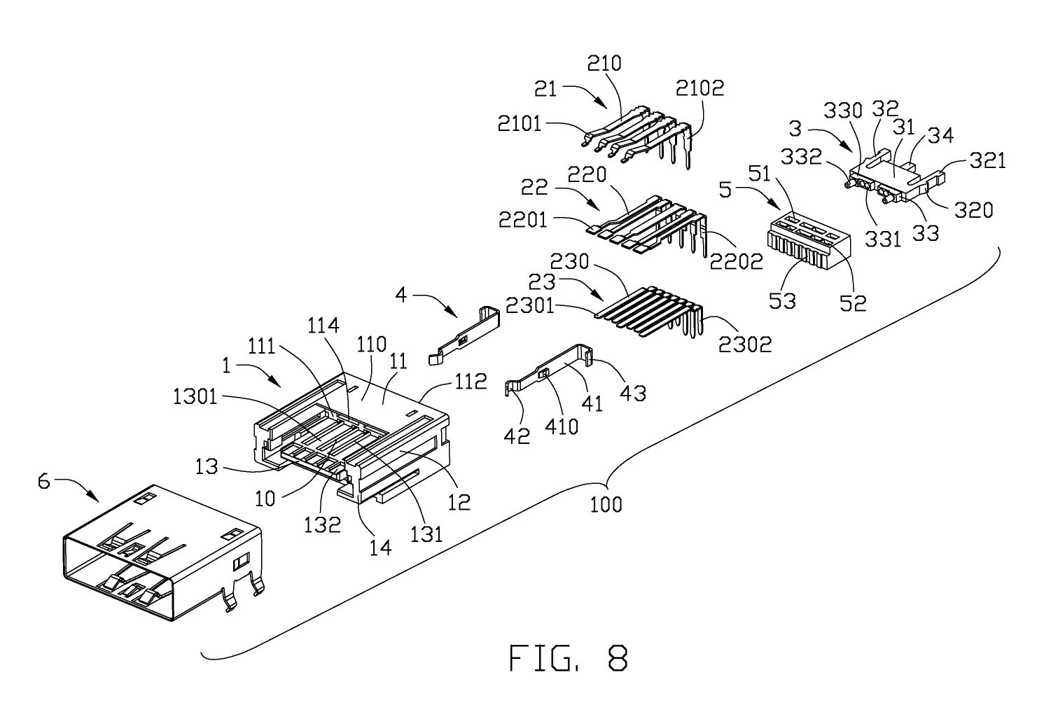

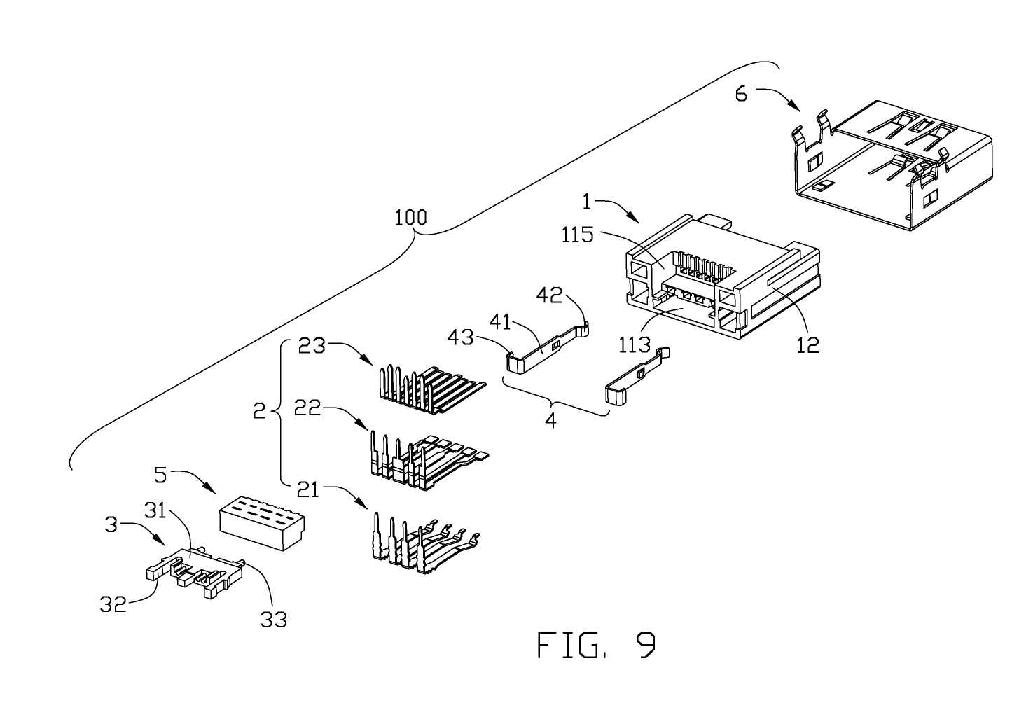

Referring FIGS. 8 and 9, the contacts 3 include four first contacts 21 assembled on the first grooves 131 on the first side surface 1301 and five second contacts 22 assembled on the second grooves 132 on the first side surface 1301 and seven third contacts 23 assembled on the third grooves 133 on the second side surface 1302. The first contacts 21 are same to that of a standard USB 2.0 receptacle (not shown) and comprise a power contact, a grounding contact and a pair of differential signal contacts between the power contact and the grounding contact. Each first contact 21 has a protruding elastic contact portion 2101 and an upright tail portion 2102. The second contacts 22 cooperating with the first contacts 21 to form contacts of a standard USB 3.0 receptacle to transmit USB 3.0 signals. Each second contact 22 has a stiff contact portion 2201 and an upright tail portion 2202. The elastic contact portions 2101 are cantileveredly received in the first grooves 131 and protruding beyond the first side surface 1301, the stiff contact portion 2201 are exposed on the second grooves 132, the stiff contact portion 2201 is closer to a front edge of the tongue 13 regarding to the elastic contact portions 2101. The third contact has an upright tail portion 2302 for engaging with E-SATA plug. In other embodiment, the first, the second or the third contact may insert-molded on the tongue 13.

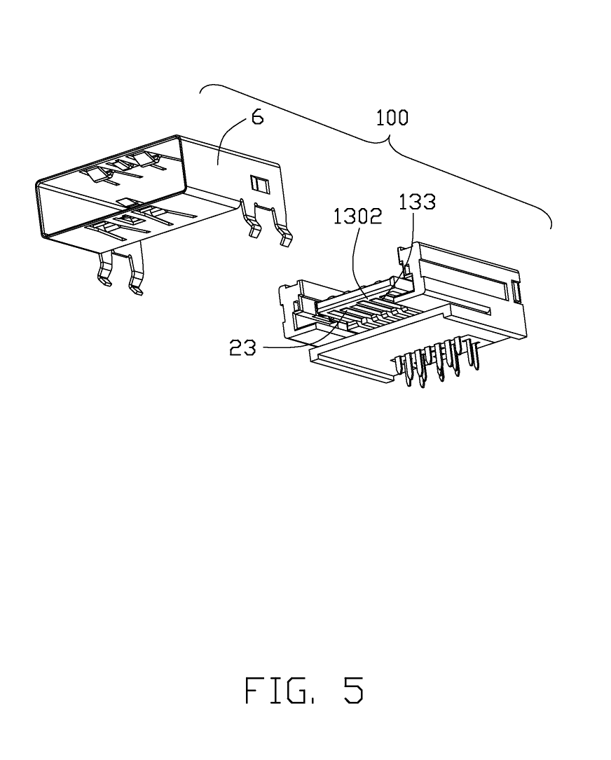

Referring to FIG. 3-5, the optical module 3 is exposed in the receiving space 10 and located on an upper and back side of the tongue 13. The optical module has a base 31 received in the mounting slot 13, a pair of latching portions 32 extending forwardly from two sides of the base 31, and two separated mating portions 32 extending forwardly from the base 31 into the mating holes 114 of the body portion 11, optical fibers (not shown) mounted within the base 31 and a pushing portion 34 extending rearward from the base 31 for being pushed by a pushing member (not shown). The base 31 and the mating portion 33 have optical fiber holes (not shown) for receiving the optical fibers (not shown). The latching portion 32 has a wedge latching protrusions 320 and an abutting portion 321 expanding outwardly from a free end thereof. The wedge latching protrusions 320 engages with the latching recess 1130 on two sides of the mounting slot 113 so as to prevent the optical module 3 from withdrawing from the mounting slot 113, the abutting portion 321 is located on a back side of the mounting slot 113, the rear surface 112 of the body portion 11 abuts against the abutting portion 321 rearward. Thus, the optical module 3 is positioned in the mounting slot 113 in the front-to-back direction. When pressing the latching portion 32 inwardly, the latching portion 32 elastically deforms inwardly, and then operator can easily remove the optical module 3 from the mounting slot 113.

The mating portion 33 has a platform 330 received in the mating hole 114, a pair of mating posts 332 protruding into the receiving space 10 from the platform 330 to position optical plug 300 and two lens 331 mounted on each platform 330. The mating portions 33 are symmetry in the right-to-left direction, the lenses 331 are located between the two mating posts 332 and exposed in the receiving space 10 for collecting optical signals. The lenses 331 are located in the front of the optical fiber holes for mating with the optical fibers (not shown). The lens 331 is seat on an upper and rear side of the contact portions 2101, 2201, 2301 and an upper and front side of the tail portions 2102, 2202, 2302. Furthermore, the lens 331 is coplanar with the front surface 111 of the body portion 11 and set on a back of the front surface 111, the mating post 332 protruding beyond the front surface 111 to position the mating plug. So, the electrical connector 100 can selectively mate with a optical plug 300 under a condition that the optical plug 300 are retained by the mating posts 332 and transmits optical signals with the lenses 331. The front surface 152 of the step portion 15 is located on a front and upper side of the mating posts 332 to prevent other plug from destroying the mating posts 332.

Referring to FIGS. 8-9, the elastic pieces 4 are symmetrically assembled on the lateral portion 12. The elastic piece 4 has a planar retaining portion 41, a clamping portion 42 extending forwardly from the retaining portion 41 into the receiving space 10, and a mounting portion 43 outwardly and vertically bend from the retaining portion 41 and then bent forwardly. The retaining portion 41 can be reliably retained in the lateral portion 12. The clamping portion can clamp the mating plug, the mounting portion 43 extends beyond the lateral portion 12 and engages with the shell.

Referring to FIGS. 8-9, the spacer 5 is mounted within the cavity 115, and defines a plurality of first retaining slots 51 and second retaining slots 52 extending in a vertical direction and arranged in a row for receiving the tail portions 2102, 2202 of the first and the second contacts 21, 22. A plurality of third retaining slots 53 is defied also, which is extending in a vertical direction and defined by recessing from a front surface of the spacer 5 for engaging with the latching slot 1151 on the rear side of the cavity 115 to cooperatively clamp the tail portion 2302 of the third contacts 23.

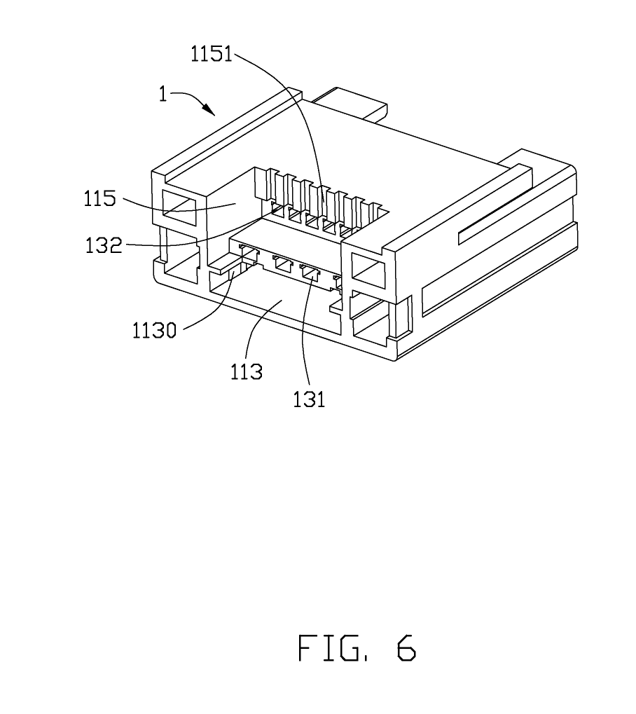

referring to FIGS. 1-6, the shell 6 covers the insulative housing 1 to form the receiving space 10 for receiving the mating plug, the shell 6 has a top wall 61 and bottom wall 62, and a pair of side walls 63 connecting the top wall 61 and the bottom wall 62. The top wall 61 and bottom wall 62 each has at least one spring arm 611, 621 extending into the receiving space 10 to abut against corresponding mating plug. The step portion 15 resists a front end of the optical plug 300, the top wall 41 abuts against the step portion 15, and the spring arm 611 resists a rear end of the optical plug 300. By such arrangement, the step portion and the spring arm 611 position the optical plug 300 in the front-to-back direction.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. An electrical connector defining a receiving space for receiving a corresponding plug, comprising:
an insulative housing having a body portion and a tongue extending forwardly from the body portion into the receiving space and a mounting slot behind to the receiving space;
a plurality of contacts disposed in the insulative housing, each contact having a contact portion exposed in the tongue, and a tail portion extending beyond the insulative housing;
an optical module forwardly assembled into the mounting slot from a rear side of the insulative housing and having at least one lens exposed to the receiving space forwardly; and
a shell covering the insulative housing to define the receiving space; wherein
a step portion is provided and extends into the receiving space, the step portion is disposed at a rear part of the receiving space near the body portion and the lens of the optical module is located between the step portion and the tongue in a top-to-bottom direction, the step portion reduces a height of the rear part of the receiving space above/under the step portion.

2. The electrical connector as claimed in claim 1, wherein the step portion is formed by the insulative housing and horizontally extends forwardly from the body portion, the step portion has a top surface being coplanar with a top surface of the body portion and abutting against the shell.

3. The electrical connector as claimed in claim 2, wherein contacts include a plurality of first contacts to transmit USB 2.0 signals, and a plurality of second contacts cooperating with the first contacts 21 to transmit USB 3.0 signals.

4. The electrical connector as claimed in claim 3, wherein the electrical connector is capability of engaging with USB 2.0/3.0 plug and optical plug, and the step portion fills a gap between the shell and the optical plug inserted into the receiving space.

5. The electrical connector as claimed in claim 4, wherein the body portion has a first limiting surface for preventing a further insertion of the optical plug, and the tongue has a second limiting surface for preventing a further insertion of the USB 2.0/3.0 plug.

6. The electrical connector as claimed in claim 2, wherein both the first and the second contacts are disposed on a same side surface of the tongue, the contacts further include a plurality of third contacts disposed on an opposite side surface of the tongue for engaging with another type plug, and the tongue has a third limiting surface for preventing a further insertion of this type plug.

7. The electrical connector as claimed in claim 2, further comprising a spacer, the insulative housing defines a cavity under the mounting slot to receive the spacer.

8. An electrical connector defining a receiving space for receiving the plugs adapted for mating with USB plug and optical plug which has a smaller height respective to the USB plug, comprising:
an insulative housing having a tongue extending forwardly into the receiving space;
a plurality of contacts disposed in the insulative housing, each contact having a contact portion exposed in the tongue and a tail portion extending beyond the insulative housing;
an optical module assembled to the insulative housing; and
a shell covering the insulative housing to define the receiving space; wherein one of the shell and the insulative housing provides a step portion protruding into a rear part of the receiving space to limit a movement of the optical plug inserted into the receiving space in a top-to-bottom direction.

9. The electrical connector as claimed in claim 8, wherein the step portion abuts against the optical plug or defines a small clearance between the optical plug to prevent the optical plug from rocking.

10. The electrical connector as claimed in claim 9, wherein a dimension of the step portion is designed to not touch the USB plug when the USB plug inserted into the receiving space.

11. The electrical connector as claimed in claim 10, wherein the tongue has a first side surface and a second side surface opposite to the first side surface, the contacts includes a plurality of first contacts and second contacts disposed on the first side surface for engaging with USB plug.

12. The electrical connector as claimed in claim 12, wherein the contacts further include a plurality of third contact disposed on the second side surface of the tongue for engaging with E-SATA plug.

13. The electrical connector as claimed in claim 12, further comprising a pair of elastic pieces assembled to the insulative housing to clamp the plug.

14. The electrical connector as claimed in claim 8, wherein the insulative housing is formed with a body portion, the tongue extends from the body portion, the body portion has a limiting surface to abut against a front end of the optical plug, and the shell has a top wall with the spring arm which resists a rear end of the optical plug.

15. An electrical connector for use with a complementary connector, comprising:
an insulative housing enclosed in a metallic shell to commonly define a mating port exposed to an exterior in a mating direction;
a mating tongue extending forwardly from a base of the housing and into the mating port, said mating tongue defining opposite first and second mating faces in the vertical direction perpendicular to said mating direction;
a plurality of first contacts disposed in the housing with first contacting sections exposed upon the first mating face;
a plurality of second contacts disposed in the housing with second contacting sections exposed upon the first mating face while being offset from the first contacting sections in the mating direction;
a plurality of third contacts disposed in the housing with third contacting section exposed upon the second mating face;
a plurality of optical elements disposed in the housing with coupling faces located behind the mating tongue in said mating direction around the first mating face; and
a flange structure extending away from the coupling face in said mating direction within the mating port and opposite to the mating tongue for restricting movement of the complementary connector in the vertical direction.

16. The electrical connector as claimed in claim 15, wherein the flange is unitarily formed with the housing.

17. The electrical connector as claimed in claim 15, wherein the housing is equipped with at least one guiding post extending away from the coupling face in said mating direction for engagement with the complementary connector.

18. The electrical connector as claimed in claim 17, wherein a dimension of the flange and that of the guiding post in the mating direction are similar to each other.

19. The electrical connector as claimed in claim 15, wherein the connector is adapted to a printed circuit board in the vertical direction under condition the second mating face faces toward the printed circuit board.
